(19) United States
(12) Patent Application Publication
(10) Pub. No.: US 2006/0143937 A1
(43) Pub. Date: Jul. 6, 2006

(54) Method for drying substrates

(76) Inventor: Christianne Eichler, Pliezhausen (DE)

Correspondence Address: ROBERT W. BECKER & ASSOCIATES, 707 HIGHWAY 66 EAST, SUITE B, TIJERAS, NM, 87059, US

(21) Appl. No.: 10/537,996

(22) PCT Filed: Nov. 13, 2003
(86) PCT No.: PCT/EP03/12689

§ 371 Date: Jun. 3, 2005

(30) Foreign Application Priority Data
Dec. 4, 2002 (DE) 102 56 696.8

(51) Int. Cl. F26B 3/00; F26B 21/06

(52) U.S. Cl. 34/351; 34/471; 34/78

(57) ABSTRACT

The invention relates to a method for drying substrates, particularly semiconductor wafers, after a wet treatment carried out in a treatment liquid. According to the invention, a gas mixture, which consists of a carrier gas and of an active constituent and which reduces the surface tension of the treatment liquid, is applied to the treatment liquid. By producing a relative motion between the substrates and the liquid, the substrates are moved out of the liquid. In order to provide a selectable, preferably constant, isopropyl alcohol (IPA) concentration at any time during the drying process, the concentration of the active constituent of the gas mixture is actively controlled or regulated. Alternatively, the gas mixture is formed, at least in part, by introducing a predetermined amount of carrier gas and a predetermined amount of liquid of the active constituent into an evaporator.

The present invention relates to a method of drying substrates, especially semiconductor wafers, after a wet treatment in a treatment liquid, according to which a gas mixture, which is comprised of a carrier gas and an active substituent, and which reduces the surface tension of the treatment liquid, is applied to the treatment liquid and the substrates are moved out of the liquid.

Such a method is known, for example, from applicants DE-A-197 03 646. With the known method, the semiconductor wafers are initially treated in a tank that is filled with treatment liquid, whereby different liquids can be introduced into the treatment tank in order to carry out different treatment steps. As a last treatment step, generally DI water, i.e. deionized water, is introduced into the treatment tank to rinse the wafers.

Subsequently, the wafers are slowly moved out of the tank, whereby previously a gas mixture of nitrogen and isopropyl alcohol (IPA) is conveyed onto the DI water. In this connection, the nitrogen serves as carrier gas, while the IPA represents an active substituent which mixes with the DI water and thereby reduces the surface tension. During the raising of the wafers out of the DI water, the water is carried off from the wafers by means of the so-called Marangoni effect, so that they are completely dry over the water surface.

For the production of the gas mixture, nitrogen is generally conveyed through liquid IPA, as a result of which the nitrogen entrains or takes up a portion of the IPA. With the known method, a constant nitrogen flow rate is set that is kept constant during the entire drying process.

During the time that the nitrogen is conveyed through, however, the IPA is cooled due to the entrainment of the IPA in the nitrogen, as a consequence of which the entire temperature of the IPA is reduced. A temperature change of the liquid IPA, however, leads to an alteration of the concentration of the IPA in the gas mixture since the ability of the nitrogen to entrain IPA decreases as the temperature drops. For example, at an IPA temperature of 22° C., the IPA concentration in the gas mixture would be approximately 30% of a lower explosion limit (LEL=Lower Explosive Level). It should be noted that, for example during the semiconductor drying, one calculates with LEL, whereby 100% LEL corresponds to 2 volume percent IPA in the gas mixture. At an IPA temperature of 15° C., the IPA concentration would correspond, for example, to 20% LEL. A typical temperature difference that could occur during successive drying processes is 2 to 3° C., which can correspond to a concentration alteration of the IPA of up to 5% LEL.

However, an alteration of the IPA concentration can considerably affect the drying process, whereby a concentration that is too low leads to an inadequate drying, and a concentration that is too great leads to a condensation of IPA on the wafers, which in turn can lead to the formation of spots and can bring about an impairment of the wafer quality.

Proceeding from the known state of the art, it is therefore an object of the present invention to provide a selectable, preferably constant, IPA concentration at any point in time of the drying process. In this connection, in particular at the interface between the gas mixture and a treatment liquid, a uniform concentration should be provided. A further object of the invention is to enable an IPA concentration in the gas mixture that can be altered in a controlled manner over the process time. The alteration should, in particular, be possible from the aspect of providing a uniform IPA concentration at the interface between the gas mixture and the treatment liquid. A further general object is the provision of optimized drying conditions without the danger of IPA condensation on the wafers.

Pursuant to the invention, the object is realized with a method of the aforementioned type in that the concentration of the active substituent in the gas mixture is controlled or regulated to achieve optimized drying conditions without the danger of condensation of the active substituent on the substrates.

Pursuant to a particularly preferred embodiment of the invention, the gas mixture that reduces the surface tension of the treatment liquid is formed by mixing essentially pure carrier gas and a mixture of carrier gas and the active substituent. With this method, by simple adjustment of the flow rate of the pure carrier gas or the mixture, the concentration of the active substituent in the final gas mixture can be adjusted. In particular, it is possible to achieve a constant concentration of the active substituent, even if the concentration in the mixture composed of carrier gas and the active substituent drops, for example by reducing the feed of the pure carrier gas. Furthermore, it is easy to increase or reduce the concentration of the active constituent in the gas mixture in order to be able to accommodate changing process conditions.

Pursuant to one embodiment of the invention, the mixture of the carrier gas and the active substituent is formed by conveying the carrier gas through a liquid of the active substituent, and the temperature of the liquid of the active substituent is controlled or regulated to a predetermined temperature in order to influence the concentration of the active substituent by means of the temperature control of the liquid.

Pursuant to an alternative embodiment of the invention, the temperature of the liquid of the active substituent is essentially kept constant in order to provide an essentially constant concentration of the active substituent in the mixture composed of carrier gas and the active substituent, whereby an alteration of concentration in the final gas mixture can be effected via the feed of the pure carrier gas.

For an alternative adjustment of the concentration, the temperature of the liquid of the active substituent is altered in a controlled manner throughout a drying process. In this connection, the concentration of the active substituent in the mixture composed of carrier gas and the active substituent is preferably measured, and the temperature of the liquid of the active substituent is adjusted as a function of the measured concentration in order to be able to provide a desired concentration at any point in time.

Pursuant to an alternative embodiment of the invention, to achieve an altered concentration of the active substituent in the gas mixture, the flow rate of the carrier gas is altered throughout a drying process. In this connection, the concentration of the active substituent is preferably measured in the mixture composed of carrier gas and the active substituent, and the flow rate of the carrier gas is adjusted as a function of the measured concentration in order to achieve the desired concentration of the active substituent in the final gas mixture.

The underlying object of the invention is furthermore realized by a method of drying substrates of the aforementioned type in that the gas mixture is at least partially formed by introducing a predetermined quantity of the carrier gas and a predetermined quantity of a liquid of the active substituent into an evaporator. The at least partial formation in an evaporator of the gas mixture that reduces the surface tension of the treatment liquid, in which evaporator predetermined quantities of a carrier gas and a liquid of the active substituent are introduced, enables a very precise control of the concentration of the active substituent in the gas mixture. Furthermore, this method enables a very rapid alteration of the concentration, especially a very rapid increase of the concentration, should this be necessary.

The concentration of the active substituent in the gas mixture is preferably controlled in a closed or open loop manner. Pursuant to one embodiment of the invention, the concentration of the active substituent is measured after the evaporator and the flow rate of the carrier gas and/or of the liquid of the active substituent is adjusted as a function of the measured concentration. This ensures a desired concentration of the active substituent. Pursuant to a particularly preferred embodiment of the invention, the concentration of the active substituent in the gas mixture is altered as a function of the position of the substrate relative to the liquid surface. This ensures that the concentration of the active substituent, especially in the region of the interface between the gas mixture and the treatment liquid, can have a desired concentration at any point in time. Concentration changes caused by flow at the interface gas mixture/treatment liquid can be compensated for by a change in concentration in the introduced gas mixture. In this connection, in particular the concentration of the active substituent in the gas mixture is altered as a function of a cross-sectional surface between the substrates and the treatment liquid. The concentration of the active substituents in the gas mixture is preferably increased as the cross-sectional surface increases, and is reduced as the cross-sectional surface is reduced.

Pursuant to a further preferred embodiment of the invention, the active substituent is isopropyl alcohol (IPA) and the average IPA concentration in the gas mixture is kept below 15%, especially below 10%, of the lower explosion level (LEL). A concentration adjustment, especially as a function of the position of the substrates, makes it possible to provide an IPA concentration that on the average is lower, and that is below the normal level, since fluctuations can be compensated for. Pursuant to a preferred embodiment of the invention, the average IPA concentration is between approximately 3% and approximately 10% of the lower LEL.

The invention will subsequently be explained in greater detail with the aid of preferred embodiments of the invention and with reference to the drawings, in which:

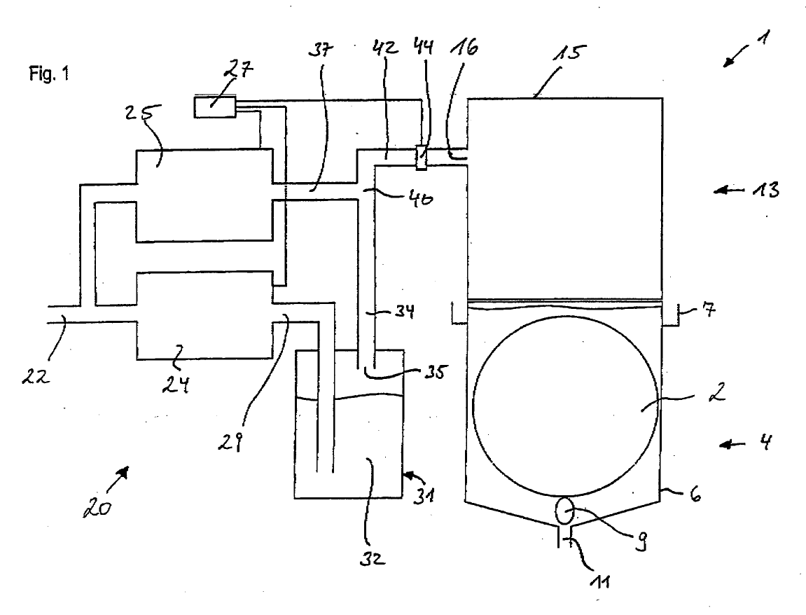

FIG. 1 shows a schematic illustration of a semiconductor treatment apparatus of the present invention;

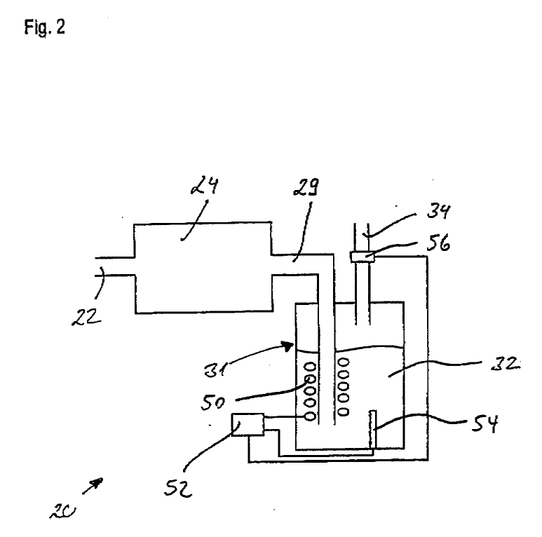

FIG. 2 shows a schematic illustration of a gas-washing bottle or bubbler pursuant to a preferred embodiment of the invention;

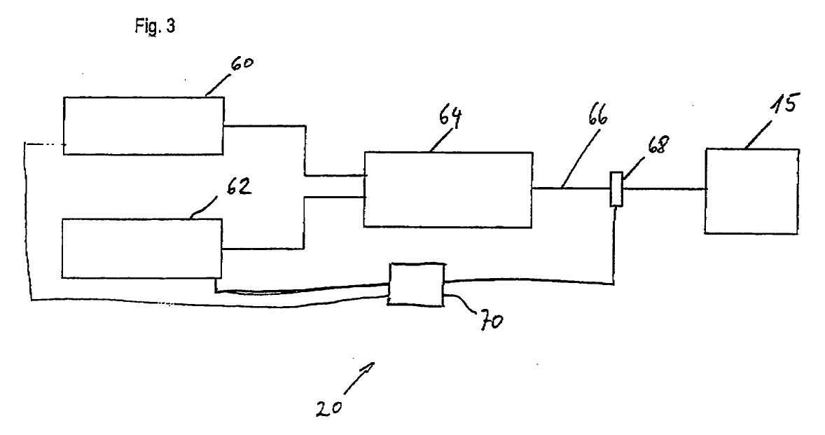

FIG. 3 shows a schematic illustration of an alternative system for producing a drying gas pursuant to the present invention;

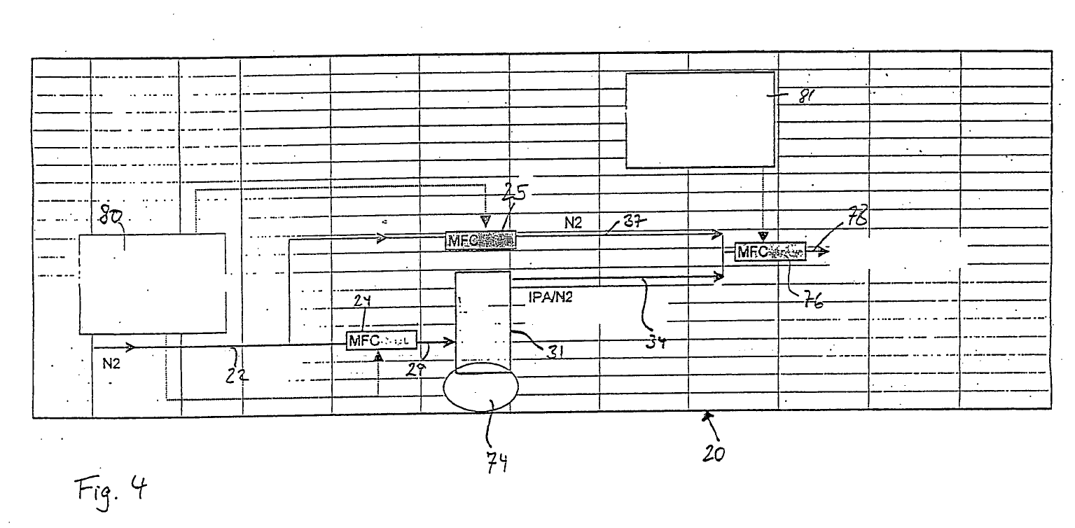

FIG. 4 shows a schematic illustration of a further apparatus for producing a drying gas pursuant to the present invention;

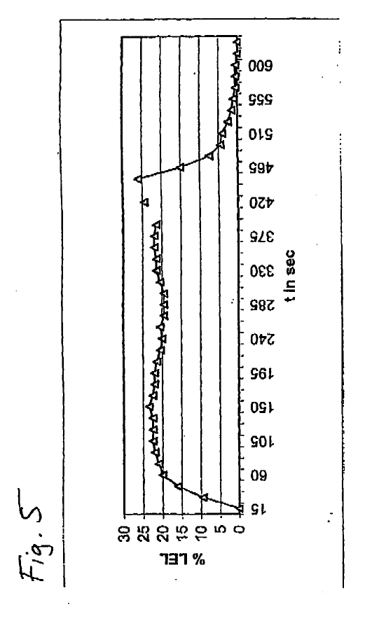

FIG. 5 illustrates a curve that shows the change of the IPA concentration during a process of drying semiconductor wafers;

FIG. 1 shows a schematic illustration of an apparatus 1 for the treatment of semiconductor wafers 2. The apparatus has a wet treatment portion 4 as is known, for example, from DE-A-197 03 646, which originates from this same applicant, and to which reference is made in order to avoid repetition. The wet treatment portion 4 is provided with a treatment tank 6 having an overflow 7. The treatment tank 6 is suitable for receiving a plurality of semiconductor wafers 2, which in FIG. 1, in the plane of the sheet, are disposed one behind the other. For this purpose, the treatment tank 6 can have guides on the side walls, or the wafers 2 can be accommodated in the tank 6 by means of a substrate carrier. Provided below the wafers 2 is a lifting element 9, which is generally designated as a blade, in order to move the wafers 2 in the tank 6 in a vertical direction for the insertion and removal of the wafers 2. The treatment tank 6 has at least one non-illustrated feed line for a treatment liquid, whereby different wet treatments can be successively carried out in the treatment tank 6 in a known manner. The treatment tank 6 is furthermore provided with an outlet 11 for the discharge of the treatment liquid. This outlet 11 is generally embodied as a rapid discharge means in order to enable a rapid discharge of the treatment liquid after the treatment.

The treatment apparatus 1 is furthermore provided with a drying portion 13 that in the embodiment illustrated in FIG. 1 essentially comprises a hood 15 having a gas inlet 16. The hood 15, in a known manner, serves for receiving the semiconductor wafers 2 after the wet treatment, and for this purpose can be provided with lateral guide rails. Furthermore, in a known manner the hood 15 can be movable for transport of the semiconductor wafers 2 accommodated therein. In FIG. 1, the hood 15 is illustrated such that it is placed over the treatment tank 6, so that the semiconductor wafers 2 can be moved out of the treatment tank 6 and directly into the hood 15. The gas inlet 16 of the hood 15 serves for the introduction of a drying gas into the hood 15. Although the gas inlet 16 is illustrated on an upper end of the hood 15, the gas inlet could also be disposed at various other positions of the hood, and it could have different configurations. Thus, for example, a plurality of gas inlet nozzles could be provided that are disposed in such a way that they are specifically directed into the spaces between the wafers that are accommodated by the hood 15.

The treatment apparatus 1 furthermore comprises a device 20 for producing the drying gas. The presently preferred drying gas is a mixture composed of a carrier gas, especially nitrogen, and an active substituent, in particular isopropyl alcohol (IPA). The IPA as active substituent serves for reducing the surface tension of the liquid, in the region of the meniscus that always occurs during the removal movement of a wafer, in such a way that the treatment liquid flows entirely off the wafer 2. This method is known in the industry as drying pursuant to the Marangoni principle.

The device 20 has a feed line 22 for nitrogen, and is connected with two quantity flow control devices, which are also designated as mass-flow-controllers (MFC). The two MFCs 24, 25 are connected to a control unit 27, as will subsequently be described in greater detail.

The MFC 24 has an outlet line 29 that leads into a gas-washing bottle 31, which is also designated as a bubbler. Liquid isopropyl alcohol (IPA) is contained in the bubbler 3, and the outlet line 29 of the MFC 24 extends into a region below the surface of the IPA liquid. The bubbler 31 furthermore has an outlet line 34 that leads to the inlet 16 of the hood 15. An inlet 35 of the outlet line 34 of the bubbler 31 is disposed above the IPA liquid 32.

Nitrogen gas, which is conveyed through the MFC 24, thus flows through the line 29 into the IPA liquid 32, and rises in the IPA liquid 32. During the rising, a portion of the IPA liquid 32 is taken up or entrained in the nitrogen gas in a known manner, resulting in a mixture of nitrogen gas and gaseous IPA above the liquid 32. This mixture is conveyed via the line 34 to the inlet 16 of the hood 15, where it is used as drying gas.

The concentration of the IPA in the gas mixture is a function, among other things, of the temperature of the introduced nitrogen, the temperature of the IPA liquid, and the pressure in the bubbler. A higher temperature of the nitrogen gas and of the IPA liquid leads to a higher concentration of the IPA in the gas mixture, since the entrainment of the IPA liquid is enhanced. Furthermore, a lower pressure in the bubbler 31 similarly leads to a higher concentration of IPA in the gas mixture.

As can be seen in FIG. 1, the second MFC 25 is disposed parallel to the first MFC 24. An outlet line 37 of the MFC 25 communicates with the outlet line 34 of the bubbler 31, and in particular upstream of where the outlet line 34 opens into the inlet 16 of the hood 15. The outlet line 37 opens at 40 into the outlet line 34, so that at this point, and in a line portion 42 that is disposed between the point 40 and the inlet 16 to the hood 15, there is effected a mixing together of the gases coming from the MFC 25 and from the bubbler 31. Disposed in the line portion 42 is a concentration-measuring unit 44 that measures the concentration of the IPA in the nitrogen/IPA mixture, with the result of the measurement being conveyed to the control unit 27.

The operation of the treatment apparatus 1 will be explained in greater detail subsequently with the aid of FIG. 1.

First, the semiconductor wafers 2 are placed into the treatment tank 6, which is filled with a treatment fluid, and subsequently the wafers are treated in a known manner with one or more treatment liquids. As a last step of the treatment, the semiconductor wafers 2 are rinsed in deionized water (DI water).

After the rinsing process, a gas mixture that is comprised of nitrogen and isopropyl alcohol, and which is produced in the section 20, is introduced into the hood 15 and is thereby applied to the surface of the DI water. In this connection, the IPA concentration in the gas mixture is determined by the measuring unit 44, and by means of a control of the flow rate via the MFCs 24 and 25, the concentration is adjusted to a predetermined value. For example, initially a somewhat greater concentration can be selected in order to rapidly make sufficient IPA available to the water surface. Subsequently, the concentration can first be reduced to a desired value that is necessary for the drying.

Subsequently, during further introduction of the gas mixture, the wafers 2 are slowly raised out of the DI water, whereby the IPA in the gas mixture effects a complete flowing off of the water from the wafers 2 pursuant to the Marangoni effect. While the wafers 2 are being raised out of the DI water, the cross-sectional area of the wafers that comes into contact with the liquid is increased. This leads to an increase of the liquid surface in the region of the meniscus. Thus, as the cross-sectional area increases absolutely more IPA is absorbed in the surface liquid. As a consequence, the IPA concentration in the gas mixture drops as the cross-sectional area increases, or increases as the cross-sectional area is reduced. Thus, there is a correlation between the cross-sectional area of the substrates with the DI water and the change in concentration of the IPA at the interface between the gas mixture and the DI water relative to the concentration of the gas mixture introduced at the inlet 16. To ensure that despite this change in concentration adequate IPA is available for a complete drying of the wafers 2, the concentration of the IPA in the gas mixture is increased during the time that the wafers 2 are raised out, and in particular until the wafers 2 have been raised halfway out of the treatment liquid; the IPA concentration is subsequently again reduced.

The IPA concentration of the gas mixture is preferably less than 15% of the lower explosion level (LEL), whereby 100% LEL corresponds to two volume percent IPA in the gas mixture. The IPA concentration is preferably less than 10% LEL, in particular between 3 and 10% LEL, and in particular depending upon process requirements.

After the semiconductor wafers 2 have been raised completely out of the DI water, no DI water is any longer supplied, and the treatment fluid in the treatment tank 6 is withdrawn via the outlet 11. During the discharge of the DI water, since there is no longer an overflow, surface water enriched with IPA can no longer be carried off. A saturation of the water with IPA occurs, and this leads to an enrichment of the concentration in the gas mixture above the water surface. This increase of the IPA concentration can be detected at the concentration-measuring unit 44 and can be compensated for via the control unit 27 by correspondingly adjusting the flow rates via the MFC 24 or 25. Instead of initially effecting a concentration increase that is recognized at the concentration-measuring unit 44, the apparatus can essentially, in an anticipatory manner, alter the gas flows by the MFC 24 or 25 as soon as the overflow has stopped and during the discharge of the water. Subsequently, the hood 15 is rinsed with pure nitrogen, and the semiconductor wafers 2 are carried off in a suitable manner either in the hood 15 or in some other manner.

The inventive apparatus, and especially the inventive method, thus enable an adjustment of the IPA concentration in the hood 15. Although in FIG. 1 a concentration-measuring unit 44 is used in order to provide regulation of the IPA concentration, the apparatus could also operate without measuring the concentration by controlling the flow rates through the MFCs 24 and 25 with the aid of prescribed parameters. Instead of providing a concentration-measuring unit in the line portion 42, i.e. between the point 40 and the inlet 16 of the hood 15, it is also possible to provide for concentration measurement in the line 34 upstream of the point 40, whereby the IPA concentration of the gas mixture exiting the bubbler 31 is then measured.

FIG. 2 shows an alternative embodiment of a gas-producing section 20 of the treatment apparatus 1, whereby in FIG. 2 the same reference numerals are used as in FIG. 1 to the extent that they reference the same or equivalent elements.

The gas-producing section 20 has a nitrogen feed line 22 that is connected with an MFC 24. An outlet line 29 of the MFC 24 extends into a bubbler 31 that is filled with liquid IPA 32. An outlet line 34 of the bubbler 31 leads to a non-illustrated inlet 16 of a hood 15.

With the embodiment illustrated in FIG. 2, no second MFC that communicates with the nitrogen feed line 22 and the outlet line 34 of the bubbler 31 is provided. However, it should be noted that a second MFC, as with the first embodiment of FIG. 1, could optionally also be provided.

The bubbler 31 has a heating coil 50 that is disposed within the liquid IPA 32 and that surrounds the outlet line 29 of the MFC 24. The heating coil 50 communicates with a control unit 52 for controlling the heating coil 50. The control unit 52 furthermore communicates with a temperature sensor 54 that is disposed in the bubbler 31, as well as with a concentration-measuring unit 56 that is disposed in the outlet line 34 of the bubbler 31.

The operation of the gas-producing section 20 of FIG. 2 will be explained in greater detail subsequently.

For the production of a gas mixture of nitrogen and IPA, introduction into the bubbler 31 via the MFC 24 is such that the nitrogen flows through the liquid IPA 32 and thereby entrains IPA in the nitrogen. The entrainment of the IPA leads to a cooling off of the remaining liquid IPA 32. However, in order to ensure a specific IPA entrainment by the nitrogen, the temperature of the liquid IPA 32 is measured by the temperature sensor 54 and is conveyed to the control unit 52. The control unit 52 controls the heating coil 50 as a function of the measured temperature in order to compensate for the cooling of the liquid IPA 32; in other words, an attempt is made to maintain a predetermined temperature of the liquid IPA 32. The heating coil 50 thus essentially serves for the compensation of the temperature losses that occur in the liquid IPA due to the IPA entrainment.

At a prescribed temperature of the liquid IPA 32, and as the nitrogen is conducted through, an essentially predetermined IPA concentration is produced in the nitrogen gas. This is measured by the concentration-measuring unit 56 in the outlet line 34 of the bubbler 31. The measurement result is conveyed to the control unit 52. If the measured IPA concentration deviates from a desired IPA concentration in the gas mixture, the control unit 52 can control the heating coil 50 in such a way that the temperature of the liquid IPA 32 is altered in order, in this way, to achieve an increased or reduced entrainment of the IPA in the nitrogen gas, whereby, however, an evaporation of the liquid IPA due to the heating coil should not occur. The control unit 52 can thus control the heating coil 50 as a function of the temperature sensor 54 and/or as a function of the measured concentration at the concentration-measuring unit 56, and can thus alter the IPA entrainment by the nitrogen gas, whereby primarily a temperature compensation is provided.

The control unit 52 is thus in a position to prevent a gradual alteration of the IPA concentration due to a cooling off of the IPA liquid. The control unit 52 is furthermore in a position to also compensate for concentration fluctuations that occur, for example due to changing pressure conditions. Furthermore, the control unit 52 can undertake an intentional concentration change of the entrained IPA by heating or cooling off the liquid IPA 32 in order, for example during the raising out of wafers, to make available an increased concentration of the IPA in the gas mixture.

Although only a single heating coil 50 is provided in FIG. 2 as a temperature control element, it is, of course, also possible to provide a heating/cooling device in the bubbler 31 through which, for example selectively or optionally, a heated or cooled liquid flows. This is in particular advantageous if an active concentration adjustment is desired by cooling the liquid IPA 32. It is also not necessary to provide the heating coil, or an alternative heating/cooling device, in the bubbler, i.e. in the liquid IPA. Rather, the heating coil, or an alternative heating/cooling device, could be provided externally of the bubbler.

FIG. 3 shows a further alternative embodiment of a gas-producing section 20 of the treatment apparatus 1. The gas-producing section has a first MFC 60 for nitrogen gas, and a second MFC 62 for liquid isopropyl alcohol (IPA). The first and second MFCs 60, 62 communicate via appropriate lines with an evaporator or vaporizer 64. The liquid IPA that has been introduced is vaporized in the evaporator 64 by supplying heat, and is mixed with the nitrogen gas that is introduced. An outlet line 66 of the evaporator communicates with the hood 15 of the treatment apparatus 1 of FIG. 1. In the line 66, between the evaporator 64 and the hood 15, a concentration-measuring unit 68 is provided for measuring the IPA concentration in the resulting gas mixture. The concentration-measuring unit 68 communicates with a control unit 70, which in turn controls the MFCs 60 and 62 via appropriate lines. The operation of the gas-producing section 20 of FIG. 3 will be described in greater detail subsequently with reference to FIG. 3.

A predetermined quantity of a nitrogen gas is continuously conveyed into the evaporator 64 via the MFC 60, while at the same time a predetermined quantity of liquid IPA is conveyed into the evaporator 64 via the MFC 62. The liquid IPA is vaporized in the evaporator 64 and is mixed with the nitrogen gas. The gas mixture that thereby results is conveyed via the line 66 into the hood 15.

The IPA concentration in the line 66 is measured by the concentration-measuring unit 68, and the measurement result is conveyed to the control unit 70. If the measured concentration deviates from a desired concentration, the control unit can alter the flow rate of the nitrogen gas through the MFC 60, or can alter the flow rate of liquid IPA through the MFC 62, in order to thereby bring about a change in concentration. With the gas-producing section 20 illustrated in FIG. 3, the concentration of the resulting gas mixture can rapidly be altered in conformity with prescribed process parameters.

Although a concentration-measuring unit 68 is illustrated in FIG. 3, it could also be eliminated, since the MFC 60 and MFC 62 enable the controlled introduction of specific quantities of nitrogen gas and liquid IPA into the evaporator 64, so that the gas mixture resulting in the evaporator 64 has a predetermined concentration. Therefore, a subsequent measurement of the concentration, with an accompanying regulation of the flow rates through the MFC 60 or 62, is not absolutely necessary.

FIG. 4 illustrates a further embodiment of a gas-producing section 20. In FIG. 4, the same reference numerals are used as in FIG. 1 to the extent that they relate to the same or equivalent elements.

The gas-producing section 20 has a feed line 22 for nitrogen gas that is connected with a first MFC 24 as well as with a second MFC 25. The MFC 24 has an outlet line 29 that communicates with a bubbler 31 in the same manner as shown in FIG. 1. The bubbler 31 has a schematically illustrated temperature control unit 74 for adjusting the temperature of the liquid IPA in the bubbler 31. The temperature control unit 74 can, for example, have the construction shown in FIG. 2 or can have any other desired construction that enables a control or regulation of the temperature of the liquid IPA in the bubbler 31.

The bubbler 31 has an outlet line 34 that leads to an MFC 76. An outlet line 78 of the MFC 76 in turn leads to the hood illustrated in FIG. 1. The MFC 25 also has an outlet line 37, which communicates with the MFC 76. The MFCs 24 and 25 are controlled by a control unit 80, while the MFC 76 is controlled by a control unit 81. Although two separate control units 80, 81 are illustrated in FIG. 4, they could also be combined into a single control unit.

It is furthermore possible to provide a concentration-measuring unit in the outlet line 34 of the bubbler or in the outlet line 78 of the MFC 76; the measurement result of the concentration-measuring unit is conveyed to the control unit 80 and/or the temperature control or adjustment device 74 in order to achieve a change in concentration of IPA in the gas mixture composed of IPA and nitrogen, as described in conjunction with FIG. 1 or with FIG. 2.

The operation of the gas-producing section 20 is effected in a manner corresponding to that of the gas-producing section of FIG. 1, whereby in addition a temperature control, as was described in conjunction with FIG. 2, is possible. However, with the gas-producing section 20 of FIG. 4 there is additionally provided an MFC 76 that in turn especially introduces a specific quantity of gas mixture composed of IPA and nitrogen into the hood 15.

FIG. 5 shows a curve that illustrates the alteration of the IPA concentration during a customary drying process of semiconductor wafers in a system having treatment tank and hood. The points that are plotted show the concentration progression in % LEL while the nitrogen flow rate through a conventional bubbler without compensation for flow and/or temperature remains the same, whereby the IPA concentration was measured in the region of the water surface. The characteristic curve was plotted during the drying of 200 mm wafers, which were disposed relative to one another at half the normal spacing.

The Y axis shows the IPA concentration in % LEL in a nitrogen/IPA gas mixture, and the X axis defines a time axis, with the time t in seconds. Different phases of the process will be explained subsequently.

During an initial, not illustrated, rinsing phase, during which the semiconductor wafers are rinsed in DI water, no gas mixture is introduced into the hood. During the rinsing phase, DI water is conveyed through the treatment tank 6 at a high rate of flow, so that it overflows into the overflow 7. After the rinsing, the rate of flow of the DI water is reduced, and an essentially flat water surface is formed.

At the time point t=0, the nitrogen flow through the bubbler is started, so that shortly thereafter an increasing IPA concentration in the hood is measured. As can be seen, the concentration increases continuously to approximately the time point t=105, and then swings to an average level of approximately 22% LEL. After reaching an essentially constant level, at approximately the time point t=120 the wafers are started to be slowly raised out of the DI water. This occurs by raising an appropriate lifting element that raises the wafers out of the DI water. At the latest at this time point, the flow rate of the DI water should be reduced in order to form the essentially flat water surface.

At the time point t=225 the wafers are raised approximately half way out, and at the time point t=375 the lifting movement of the lifting element is stopped. At this time point, the wafers are raised completely out and are disposed above the water surface.

As can be seen in FIG. 5, during the time that the wafers are being raised out, the IPA concentration temporarily drops to below 20% LEL, although the nitrogen flow rate through the bubbler was kept constant. This dropping and subsequent rising of the IPA concentration to the starting level, prior to the raising out, is due to the alteration of the meniscus surface and the thereby resulting change of the absolute quantity of dissolved IPAs in the water surface during the raising of the wafers out of the DI water, as already previously mentioned.

Subsequently, at the time point t=435, discharge of the DI water is begun, which is normally effected via a rapid discharge valve. At the time point t=450, the IPA feed is adjusted, and at the time point t=465 the nitrogen flow rate is adjusted. As can be seen in FIG. 5, the IPA concentration within the gas mixture initially increases, which among other things can be attributed to an enrichment of the IPA in the gas mixture which occurs since, due to the lack of overflow, DI water enriched with IPA is no longer carried off. After the increase of the IPA concentration, it drops quickly, which is caused by termination of the IPA feed and a subsequent brief rinsing with pure nitrogen. This causes the IPA concentration to drop to zero.

The invention was described with the aid of preferred embodiments of the invention without being limited to the specially illustrated embodiments. For example, the principles of the present invention can also be used with a system where the wafers are not raised out of the treatment liquid by means of a lifting device, but rather are moved out of the treatment liquid by means of a discharge of the treatment liquid. The features of the various embodiments can be freely combined or exchanged with one another as long as they are compatible.

1-15. (canceled)

16. A method of drying substrates after a wet treatment thereof in treatment liquid, including the steps of:
forming a gas mixture that comprises a carrier gas and an active substituent, and that reduces the surface tension of the treatment liquid, by conveying the carrier gas through a liquid of the active substituent;
actively controlling a concentration of the active substituent in the gas mixture in an open or closed loop manner;
actively controlling a temperature of the liquid of the active substituent to a predetermined temperature in an open or closed loop manner;
applying the gas mixture to the treatment liquid; and
moving the substrates out of the treatment liquid by generating a relative movement between the substrates and the treatment liquid.

17. A method according to claim 16, wherein the gas mixture is formed by mixing essentially pure carrier gas and a mixture of carrier gas and the active substituent.

18. A method according to claim 16, wherein the temperature of the liquid of the active substituent is kept essentially constant.

19. A method according to claim 16, wherein the temperature of the liquid of the active substituent is altered in a controlled manner throughout a drying process.

20. A method according to claim 19, wherein the concentration of the active substituent in the gas mixture is measured, and wherein the temperature of the liquid of the active substituent is adjusted as a function of the measured concentration.

21. A method according to claim 16, wherein a flow rate of the carrier gas is controlled in an open or closed loop manner.

22. A method according to claim 21, wherein the flow rate of the carrier gas is altered throughout a drying process.

23. A method according to claim 21, wherein the concentration of the active substituent in the gas mixture is measured, and the flow rate of the carrier gas is adjusted as a function of the measured concentration.

24. A method according to claim 16, wherein the gas mixture is at least partially formed by introducing a predetermined quantity of the carrier gas and a predetermined quantity of a liquid of the active substituent into an evaporator.

25. A method according to claim 24, wherein the concentration of the active substituent in the gas mixture is measured downstream of the evaporator, and wherein a flow rate of at least one of the carrier gas and the liquid of the active substituent is adjusted as a function of the measured concentration in order to obtain a predetermined concentration.

26. A method according claim 16, wherein the concentration of the active substituent in the gas mixture is altered as a function of a position of the substrates relative to a surface of the treatment liquid.

27. A method according to claim 26, wherein the concentration of the active substituent in the gas mixture is increased as a cross-sectional surface between the substrates and the treatment liquid increases, and is decreased as the cross-sectional surface is decreased.

28. A method according to claim 16, wherein the active substituent is isopropyl alcohol (IPA), and wherein the average IPA concentration in the gas mixture is kept below 15% of a lower explosion level (LEL).

29. A method according to claim 28, wherein the average IPA concentration in the gas mixture is kept below 10% of the lower explosion level (LEL).

30. A method according to claim 28, wherein the average IPA concentration in the gas mixture is kept between 3 and 10% of the lower explosion level (LEL).
